(19) United States
(12) Patent Application Publication
(10) Pub. No.: US 2021/0191585 A1
(43) Pub. Date: Jun. 24, 2021

(54) INFORMATION PROCESSING APPARATUS AND NON-TRANSITORY COMPUTER READABLE MEDIUM STORING COMPUTER PROGRAM

(71) Applicant: FUJI XEROX CO., LTD., Tokyo (JP)

(72) Inventor: Kazutoshi YATSUDA, Kanagawa (JP)

(73) Assignee: FUJI XEROX CO., LTD., Tokyo (JP)

(21) Appl. No.: 16/852,541

(22) Filed: Apr. 19, 2020

(30) Foreign Application Priority Data
Dec. 23, 2019 (JP) 2019-231532

(51) Int. Cl. G06F 3/0484; G06F 16/28; G06F 16/26

(52) U.S. Cl. CPC G06F 3/0484; G06F 16/26; G06F 16/288

(57) ABSTRACT

An information processing apparatus includes a processor configured to execute a process of presenting a quantitative relationship between plural items having a relationship in association with display of the items on a relational diagram, the relational diagram being systematically created by connecting the items having the relationship to each other according to the relationship.

### CROSS-REFERENCE TO RELATED APPLICATIONS

This application is based on and claims priority under 35 USC 119 from Japanese Patent Application No. 2019-231532 filed Dec. 23, 2019.

### BACKGROUND

### (i) Technical Field

The present invention relates to an information processing apparatus and a non-transitory computer readable medium storing a computer program.

### (ii) Related Art

JP2016-081185A discloses the invention relating to an information processing apparatus in which, with respect to plural of function items each indicating a function related to quality function deployment, a relational diagram is systematically created by connecting function items having dependency to each other according to the dependency and is created by imparting attribute information for specifying a process including a function item to the function item indicating a function included in any of plural of processes related to the quality function deployment among the plural function items, the information processing apparatus including a reception unit that receives the relational diagram, and thus extracts information for specifying the function item, the attribute information imparted to the function item, and dependency information for specifying the dependency of each function item, and receives the extracted information as original information; a deployment unit that classifies the function items for each process on the basis of the attribute information of the original information, creates deployment information for deploying the classified function items for each process, and deploys the original information in a deployment table in which the function items are deployed with the processes as axes, on the basis of the deployment information; and an output unit that outputs the deployment table created by the deployment unit.

### SUMMARY

In a case where an expression of a quantitative relationship between items is displayed in a table that is different from a relational diagram, the association with a quantitative relationship between associated items expressed on the relational diagram is hardly visually recognized.

Aspects of non-limiting embodiments of the present disclosure relate to an information processing apparatus and a non-transitory computer readable medium storing a computer program that present a relational diagram that facilitates visual recognition regarding a quantitative relationship between items compared with a case where an expression of the quantitative relationship between the items is displayed in a table that is different from the relational diagram.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to execute a process of presenting a quantitative relationship between a plurality of items having a relationship in association with display of the items on a relational diagram, the relational diagram being systematically created by connecting the items having the relationship to each other according to the relationship.

### BRIEF DESCRIPTION OF THE DRAWINGS

Exemplary embodiment(s) of the present invention will be described in detail based on the following figures, wherein:

FIG. 1 is a diagram illustrating a schematic configuration of an information processing system according to the present exemplary embodiment;

FIG. 2 is a block diagram illustrating a hardware configuration of a server;

FIG. 3 is a block diagram illustrating an example of a functional configuration of the server;

FIG. 4 is an explanatory diagram illustrating a data structure example of a relational diagram information table;

FIG. 5 is an explanatory diagram illustrating a data structure example of an item information table;

FIG. 6 is an explanatory diagram illustrating a data structure example of a relation line information table;

FIG. 7 is a flowchart illustrating a flow of a relational diagram editing process performed by the server;

FIG. 8 is a diagram illustrating an example of a user interface provided by the server;

FIG. 9 is a diagram illustrating an example of a user interface provided by the server;

FIG. 10 is a diagram illustrating an example of a user interface provided by the server; and

FIG. 11 is a diagram illustrating an example of a user interface provided by the server.

### DETAILED DESCRIPTION

Hereinafter, an exemplary embodiment of the present disclosure will be described with reference to the drawings. Throughout the drawings, identical or equivalent constituent elements and portions are given identical reference numerals. A dimensional ratio of the drawing is exaggerated for convenience of description, and may thus be different from an actual ratio.

First, the circumstances in which the present inventor has reached the exemplary embodiment of the present invention will be described.

In a system using complex physical phenomena, for example, with respect to a result such as final quality of a product, many events are successively linked to each other, for example, there are many events causing the result, there are many events causing the events as a result, and there are many events causing the events as a result. In such a complex system, there many qualities to be satisfied, a causal relationship between a design group and a quality group becomes considerably complex. Thus, finding out a design item for satisfying a predetermined quality is hard, and a problem that a change of a design value for satisfying a certain quality exerts adverse influence on another quality tends to occur.

As information for visualizing and summarizing the complex causal relationship, there is relational information. The relational information indicates information defining a causal relationship between a cause and a cause. The relational information includes, for example, a relational diagram in which a causal relationship is expressed by connecting a result to a cause thereof with a relation line. As an example of the relational diagram, there is a logic tree. The relational diagram is appropriate to show results and causes thereof in detail without omission or overlapping.

The relational information includes, for example, a quality function deployment table in which a relationship among events listed on plural axes orthogonal to each other is indicated by symbols or numerical values disposed in a matrix form. In the quality function deployment table, predetermined events are extracted from many events and are disposed on axes, and a causal relationship is expressed in a matrix, and thus it is possible to briefly express relationships between multiple results and multiple causes.

However, in a case where target events are too many, the relational diagram is excessively complex and enlarged. The quality function deployment table cannot express a detailed causal relationship including an event not disposed on an axis, and thus omission of an item tends to occur.

In a quality function deployment table that is generally widely created, a cause and a result are disposed on two axes such as a transverse axis and a longitudinal axis, and, thus, inherently, the table cannot have information regarding a reason why a relationship therebetween is provided. However, three or more axes are disposed to be orthogonal to each other, and predetermined causes are extracted and described from causes resulting in a causal relationship, so that multi-axis quality function deployment for expressing a rough causal relationship is effective.

From the above description, a relational diagram and a multi-axis quality function deployment table are used together, and thus relationships between multiple causes and results can be briefly displayed while extracting and describing causal relationships in detail without omission and overlapping. However, conversion between the relational diagram and the multi-axis quality function deployment table is complicated, and, to do so, a system supporting the conversion is required to be used.

The invention disclosed in JP2016-081185A proposes that an event corresponding to each axis of the quality function deployment table is selected on the created relational diagram, and then is deployed on the quality function deployment table. However, the invention cannot express a quantitative relationship between items in the relational diagram.

The invention disclosed in JP4893078B relates to a technique in which a calculation formula is recorded in a detailed description filed of a result node that is displayed separately from a relational diagram, by using words such as an explanation and calculation symbols described in a cause node. However, in a case where the result node is displayed separately from the relational diagram, visual recognition such as a connection between a result and a cause cannot be acquired, and thus to expedite decision making for a purpose in consideration of quantitativeness is difficult.

However, since a calculation formula formed of words such as an explanation written in the detailed description filed of the result node is redundant, in a case where the calculation formula is described in the relational diagram, the relational diagram is complicated and enlarged. Particularly, in a case of examining a system, the number of target events is increased, and, thus, in a case where a calculation formula is described in the relational diagram, the relational diagram becomes long and large. In a case where the relational diagram becomes long and large, to recognize an outline of the relational diagram is hard, and thus the readability of the relational diagram deteriorates.

Thus, in a case where quality of a product is designed or a case where a defect is inspected while checking association and a quantitative relationship together and also causing decision making to progress, causes connected to each other via a relational diagram are examined or summarized with respect to retrieval of a condition for a design item (cause) in which a quality (result) is established in the former case and with respect to extraction of a condition for a design item (cause) in which a quality (result) is not established in the latter case. However, in a case where a quantitative relationship cannot be recognized from the relational diagram, the relational diagram is hardly used to recognize a quantitative relationship applied to simulation.

Therefore, in the present exemplary embodiment, a description will be made of a technique capable of presenting a relational diagram that facilitates visual recognition regarding a quantitative relationship between items compared with a case where an expression of the quantitative relationship between the items is displayed in a table that is different from the relational diagram.

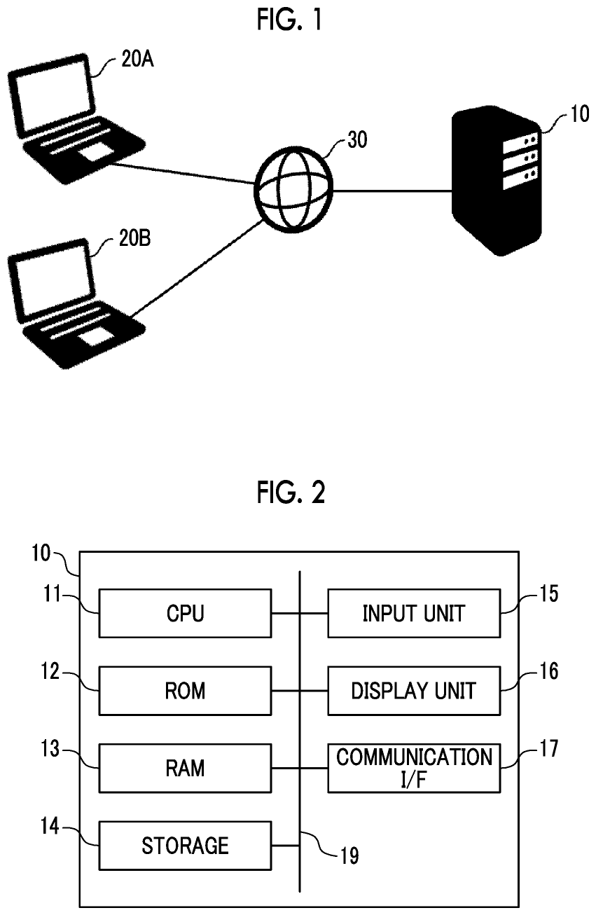

FIG. 1 is a diagram illustrating a schematic configuration of an information processing system according to the present exemplary embodiment. FIG. 1 illustrates a server 10 as an information processing apparatus, and user terminals 20A and 20B.

The server 10 is an apparatus that outputs a relational diagram in which a relationship between causes is described. The relational diagram is a diagram expressing a relationship by connecting function items to each other via a relational line. In the present exemplary embodiment, the server 10 has a function of receiving an input regarding creation of a relational diagram from the user terminals 20A and 20B and generating a relational diagram according to the received input. The user terminals 20A and 20B may receive inputs regarding creation of different relational diagrams from users.

The present exemplary embodiment may be applied to a relational diagram creation process of performing a process for obtaining a relational diagram in quality function deployment. For example, in design of a product or a service, a design quality satisfying customers is set, and the quality function deployment is used to check a dependency with each function item or a configuration such that the set design quality is realized. In the quality function deployment, an actual dependency is required to be appropriately checked, and, thus, in this quality function deployment, function items such as many design qualities are set accurately and without being omitted (without being overlooked). In the quality function deployment, one or plural processes are used as axes among a series of associated processes, and each function item (element) of the process is hierarchized and systematically displayed such that a correspondence relationship among the respective function items is clarified.

In quality function deployment of various cases, the present exemplary embodiment is used to create a relational diagram indicating correspondence relationships (dependencies) of function items between two processes by combining correspondence relationships (for example, correspondence relationships in a deployment table having a process as an axis) of the two associated processes with each other. The created relational diagram may be deployed to a two-way table in the quality function deployment. The two-way table in the quality function deployment may include various tables such as a requested quality deployment table, a quality element (characteristic) deployment table, a planned quality setting table, a designed quality setting table, a function deployment table, a mechanism deployment table, a unit/component deployment table, a construction method deployment table, a seed deployment table, and a cost deployment table. The two-way table includes various tables such as a cost planning setting table, a material deployment table, an FT deployment table, a reliability planning setting table, a measurement instrument deployment table, a measurement method deployment table, a button function deployment table, a technique deployment table, a QA table, a QC process table, and a guarantee item deployment table, and a relational diagram created according to the present exemplary embodiment can be deployed to such various tables. Such various tables are not limited thereto, and are used to create a two-way table indicating a correspondence relationship between predetermined processes on the basis of a relational diagram created according to the present exemplary embodiment.

A relational diagram created according to the present exemplary embodiment is not limited to two processes, and is used to create a chart related to quality function deployment representing correspondence relationships of function items among respective processes by combining correspondence relationships of two or more (for example, three or four) processes. In the following description, the chart related to quality function deployment representing correspondence relationships of plural processes will be referred to as a “multi-way table”. In other words, in the following description, a multi-way table indicating correspondence relationships of two processes will be referred to as a two-way table, a multi-way table indicating correspondence relationships of three processes will be referred to as a three-way table, and a multi-way table indicating correspondence relationships of four processes will be referred to as a four-way table. In the present exemplary embodiment, the process indicates a series of activities that are associated with each other or act on each other with respect to a target case, such as quality-performance-structure-material, and, between associated processes, an output of one process acts as an input of the other process (refer to JIS Q 9000 or the like).

The user terminals 20A and 20B are apparatuses that are connected to the server 10 via a network 30 such as the Internet or an intranet, and receive inputs from users with respect to creation of a relational diagram. The user terminals 20A and 20B are terminals used by different users. FIG. 1 illustrates two user terminals, but, in the information processing system, any number of user terminals may be used. Each user terminal may be any apparatus having a connection function to the network 30, such as a personal computer, a smart phone, and a tablet terminal. In the following description, in a case where the user terminals 20A and 20B are not required to be differentiated from each other, the user terminals 20A and 20B will be simply referred to as user terminals 20.

FIG. 2 is a block diagram illustrating a hardware configuration of the server 10.

As illustrated in FIG. 2, the server 10 includes a central processing unit (CPU) 11, a read only memory (ROM) 12, a random access memory (RAM) 13, a storage 14, an input unit 15, a display unit 16, and a communication interface (I/F) 17. The respective constituent elements are communicably connected to each other via a bus 19.

The CPU 11 is a central processing unit, and executes various programs or controls each unit. In other words, the CPU 11 reads a program from the ROM 12 or the storage 14, and executes the program by using the RAM 13 as a work region. The CPU 11 controls each of the constituent elements and performs various calculation processes according to the programs recorded in the ROM 12 or the storage 14. In the present exemplary embodiment, a relational diagram editing program that allows a user to edit a relational diagram is stored in the ROM 12 or the storage 14.

The ROM 12 stores various programs and various pieces of data. The RAM 13 is used as a work region, and temporarily stores a program or data. The storage 14 is configured with a storage device such as a hard disk drive (HDD) , a solid state drive (SSD), or a flash memory, and stores various programs including an operating system, and various pieces of data.

The input unit 15 includes a pointing device such as a mouse, and a keyboard, and is used to perform various inputs.

The display unit 16 is, for example, a liquid crystal display, and displays various pieces of information. The display unit 16 may function as the input unit 15 by using a touch panel type.

The communication interface 17 is an interface used to perform communication with other apparatuses such as the user terminals 20, and employs standards such as Ethernet (registered trademark), FDDI, or Wi-Fi (registered trademark).

In a case where the relational diagram editing program is executed, the server 10 realizes various functions by using the hardware resources.

Next, a functional configuration of the server 10 will be described.

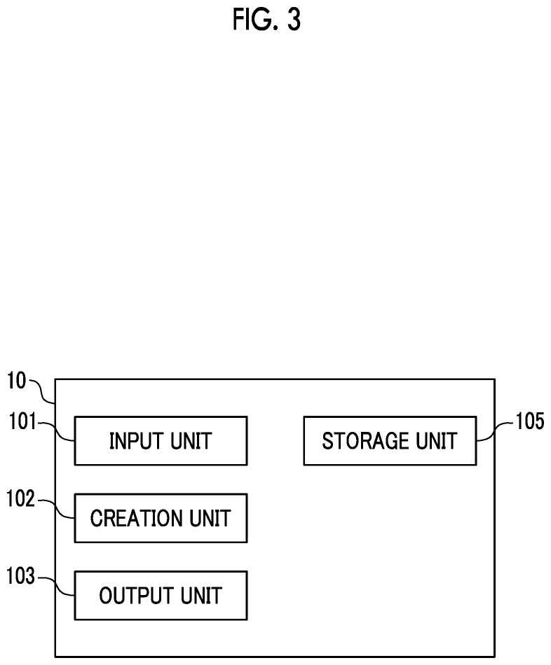

FIG. 3 is a block diagram illustrating an example of a functional configuration of the server 10.

As illustrated in FIG. 3, the server 10 includes an input unit 101, a creation unit 102, an output unit 103, and a storage unit 105 as functional constituent elements. Each functional constituent element is realized by the CPU 11 reading and executing a relational diagram display program stored in the ROM 12 or the storage 14.

The input unit 101 receives a user's input regarding creation of a relational diagram from the user terminal 20. The input regarding creation of a relational diagram includes various inputs regarding creation of a relational diagram, such as setting of an item, setting of attribute information for an item, a connection between items, and setting a process for an items. The server 10 displays a user interface for creating a relational diagram on a screen of the user terminal 20. The input unit 101 receives information regarding a relational diagram, an item, and a relation line, created on the user interface of the user terminal 20 by the user operating keys of the keyboard and the mouse. The input unit 101 performs not only reception of the user's operation on the keys of the keyboard but also reading of information stored in a hard disk (which is built into a computer but also include a hard disk connected thereto via the network) or the like.

The creation unit 102 creates a relational diagram on the basis of the information received by the input unit 101. For example, the creation unit 102 performs editing (including addition and deletion) of an item, editing of an attribute of the item (for example, the name and a characteristic of the item), reattachment (including addition and deletion) of a relation line, and editing of an attribute (for example, an intensity and a direction) of the relation line, in response to the user's editing operation received by the input unit 101. Anew item and another item that having an identical or similar attribute present already at a position on a relational diagram that is different from a relational diagram of the new item are separately displayed at different positions or are integrally displayed at an identical position, in response to the user's operation on a screen displayed by the output unit 103.

In the present exemplary embodiment, in a case where a relational diagram is created, the creation unit 102 creates the relational diagram such that a quantitative relationship between items having a relationship therebetween is presented in association with display of the items on the relational diagram. For example, the creation unit 102 creates the relational diagram such that the quantitative relationship is presented inside a frame displaying the items on the relational diagram. For example, the creation unit 102 creates the relational diagram such that the quantitative relationship is linked to a frame displaying the items on the relational diagram and is presented outside the display frame. For example, the creation unit 102 creates the relational diagram such that the quantitative relationship is presented at a location where lines extending from a frame, the frame displaying an item corresponding to an event representing an associated cause with respect to an item corresponding to an event representing a result. The quantitative relationship between items having a relationship therebetween is, for example, a relationship represented by a formula using a variable set for each of the connected items. The variable is represented by a character string configured with alphabets, Greek letters, hiragana, katakana, numbers, or a combination thereof. An example of the relational diagram created by the creation unit 102 will be described later in detail.

The output unit 103 outputs the relational diagram created by the creation unit 102. An output destination of the relational diagram is the user terminal 20 that has received the user's input regarding creation of the relational diagram. The output unit 103 stores information regarding the relational diagram created by the creation unit 102 into the storage unit 105.

The storage unit 105 stores various pieces of information regarding an operation of the server 10. In the present exemplary embodiment, the storage unit 105 stores information regarding the relational diagram. For example, the storage unit 105 stores a relational diagram information table, an item information table, and a relation line information table. Here, a description will be made of an example of the information regarding the relational diagram stored in the storage unit 105.

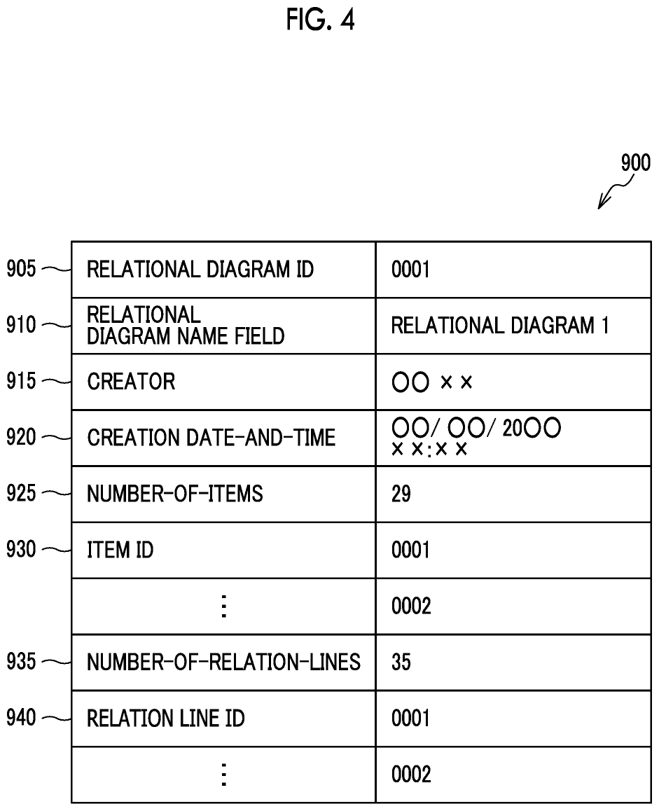

FIG. 4 is an explanatory diagram illustrating a data structure example of a relational diagram information table 900. The relational diagram information table 900 has a relational diagram ID field 905, a relational diagram name field 910, a creator field 915, a creation date-and-time field 920, a number-of-items field 925, an item ID field 930, a number-of-relation-lines field 935, and a relation line ID field 940. The relational diagram ID field 905 stores information (relational diagram identification (ID)) for uniquely identifying a relational diagram in the present exemplary embodiment. The relational diagram name field 910 stores the name of the relational diagram having the relational diagram ID. The creator field 915 stores a creator of the relational diagram. The creation date-and-time field 920 stores the date and time (which may be year, month, day, hour, minute, second, second or less, or a combination thereof) on which the relational diagram is created or edited. The number-of-items field 925 stores the number of items in the relational diagram. The item ID fields 930 corresponding to the number of items in the number-of-items field 925 are subsequent thereto. The item ID field 930 stores information (item ID) for uniquely identifying an item in the present exemplary embodiment. Information indicated by the item ID is stored in an item information table 1000. The number-of-relation-lines field 935 stores the number of relation lines in the relational diagram. The relation line ID fields 940 corresponding to the number of relation lines in the number-of-relation-lines field 935 are subsequent thereto. The relation line ID field 940 stores information (relation line ID) for uniquely identifying a relation line in the present exemplary embodiment. Information indicated by the relation line ID is stored in a relation line information table 1100.

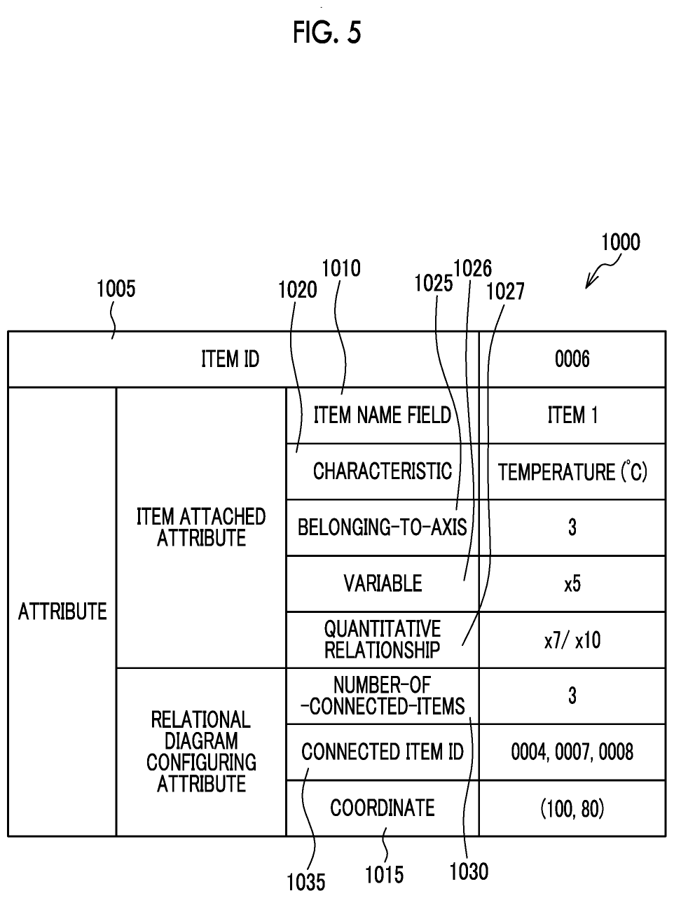

FIG. 5 is an explanatory diagram illustrating a data structure example of the item information table 1000. The item information table 1000 has an item attached attribute that is an attribute attached to an item and a relational diagram configuring attribute that is an attribute for configuring a relational diagram, as attributes prepared for each item ID. The item attached attribute is an attribute such as an item name, characteristics, or an axis to which an item belongs. The characteristics mentioned here are property, a behavior, and an action. The relational diagram configuring attribute is an attribute such as the number of connected items, a connected item ID, or a coordinate.

Due to the relational diagram configuring attribute, the item information table 1000 has an item ID field 1005, an item name field 1010, a coordinate field 1015, a characteristic field 1020, a belonging-to-axis field 1025, a variable field 1026, a quantitative relationship field 1027, a number-of-connected-items field 1030, and a connected item ID field 1035. The item ID field 1005 stores an item ID. The item name field 1010 stores the name of an item having the item ID. The coordinate field 1015 stores a coordinate at which the item is stored on the relational diagram. The characteristic field 1020 stores characteristics of the item. The belonging-to-axis field 1025 stores an axis to which an axis item corresponding to the item belongs in a case where the relational diagram is converted into a deployment diagram. The variable field 1026 stores a variable set for the item. The quantitative relationship field 1027 stores a quantitative relationship between the item and an item having a relationship with the item. The number-of-connected-items field 1030 stores the number of items connected to the item, that is, a sum of the number of connection destination items in a case where the item is a connection source item and the number of connection source items in a case where the item is a connection destination item. The connected item ID fields 1035 corresponding to the number of items in the number-of-connected-items field 1030 are subsequent thereto. The connected item ID field 1035 stores a connection destination item ID and a connection source item ID.

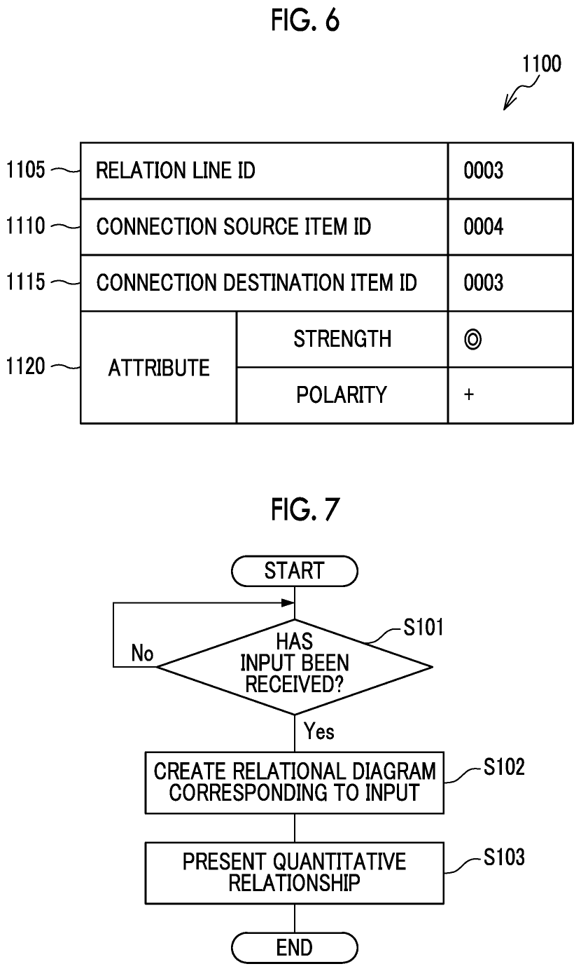

FIG. 6 is an explanatory diagram illustrating a data structure example of the relation line information table 1100. The relation line information table 1100 has a relation line ID field 1105, a connection source item ID field 1110, a connection destination item ID field 1115, and an attribute field 1120. The relation line ID field 1105 stores a relation line ID. The connection source item ID field 1110 stores an item ID of an item that is a connection source of the relation line. The connection destination item ID field 1115 stores an item ID of an item that is a connection destination of the relation line. The attribute field 1120 stores an attribute of the relation line. As the attribute, for example, there is a polarity of the relation line. The polarity is a property indicating a relationship (for example, direct preparation) in which an increase in the number of connection source items results in an increase in the number of connection destination items or a relationship (for example, inverse preparation) in which an increase in the number of connection source items results in a decrease in the number of connection destination items. As the attribute, for example, there is the strength of a relationship extent of the relation line or a direction of a relationship.

The tables illustrated in FIGS. 4 to 6 are only examples, and other data structures may be used. For example, a data structure indicating a graph structure may be used.

The information regarding the relational diagram may not be stored in the storage unit 105. The information regarding the relational diagram may be stored in an apparatus separate from the server 10.

The server 10 has the configuration illustrated in FIG. 3, and may thus present a relational diagram that facilitates visual recognition regarding a quantitative relationship between items compared with a case where an expression of the quantitative relationship between the items is displayed in a table that is different from the relational diagram.

Next, a description will be made of an operation of the server 10.

FIG. 7 is a flowchart illustrating a flow of a relational diagram display process performed by the server 10. The CPU 11 reads the relational diagram display program from the ROM 12 or the storage 14, and develops and executes the program on the RAM 13, and thus the relational diagram display process is performed.

The CPU 11 waits for an input regarding editing of a relational diagram to be received from the user terminal 20 (step S101).

In a case where the input regarding editing of a relational diagram is received from the user terminal 20 (Yes in step S101) , the CPU 11 creates a relational diagram in response to the input from the user terminal 20 (step S102). In a case where an input regarding creation of a relational diagram is, for example, setting of an item, the CPU 11 displays an item corresponding to the input on the relational diagram. In a case where an input regarding creation of a relational diagram is, for example, setting of attribute information for an item, the CPU 11 displays attribute information corresponding to the input on the relational diagram or stores the attribute information into the item information table 1000. In a case where an input regarding creation of a relational diagram is, for example, connection between items, the CPU 11 displays a line connecting items to each other on the relational diagram or stores information regarding connection between the items into the relation line information table 1100.

After step S102, the CPU 11 presents a quantitative relationship between items having a relationship therebetween in the created relational diagram in association with display of the items on the relational diagram (step S103) . The CPU 11 acquires a quantitative relationship by referring to the information stored in the quantitative relationship field 1027 of the item information table 1000, and presents the acquired quantitative relationship on the relational diagram.

The CPU 11 executes a series of operations illustrated in FIG. 7, and may thus present a relational diagram that facilitates visual recognition regarding a quantitative relationship between items compared with a case where an expression of the quantitative relationship between the items is displayed in a table that is different from the relational diagram.

Next, a description will be made of an example of a user interface provided to the user terminal 20 from the server 10.

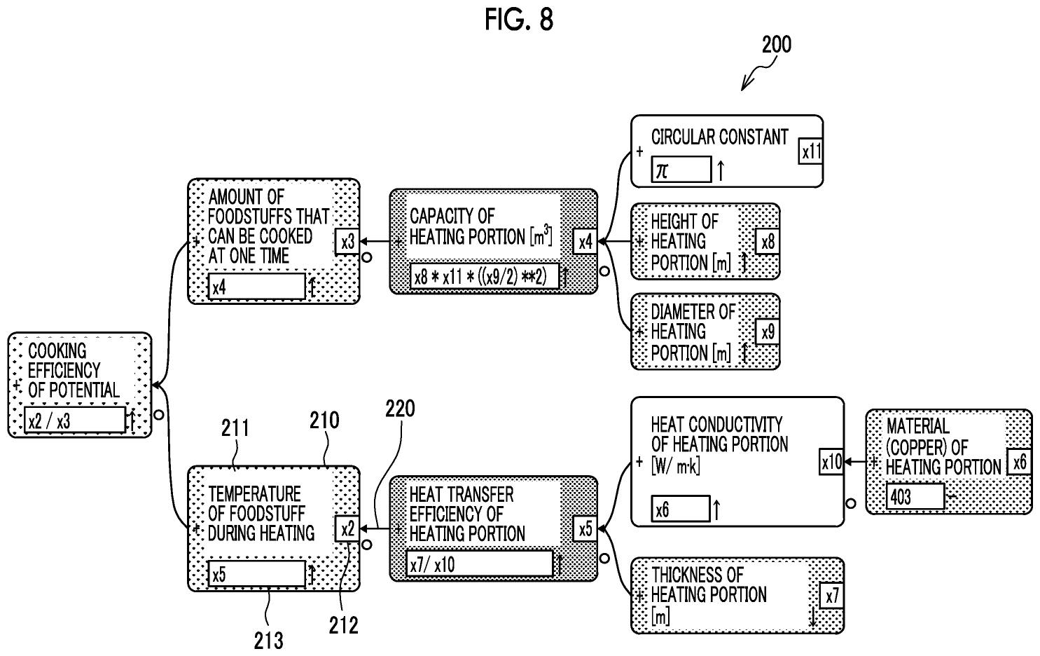

FIG. 8 is a diagram illustrating an example of a user interface provided to the user terminal 20 from the server 10. FIG. 8 illustrates a state in which a relational diagram 200 created by a user is displayed on the user interface.

In the relational diagram 200 illustrated in FIG. 8, item display frames 210 displaying respective items are connected to each other via a line 220 indicating a relationship between the items. An item's name 211, an item's variable 212, and a quantitative relationship 213 between items related to each item are presented in the item display frame 210. The server 10 acquires the item's name 211 from the item name field 1010 of the item information table 1000, and acquires the item's variable 212 from the variable field 1026 thereof. The server acquires the quantitative relationship 213 from the quantitative relationship field 1027 of the item information table 1000.

In the relational diagram 200 illustrated in FIG. 8, for example, a variable x5 is set for “heat transfer efficiency of a heating portion”, and the quantitative relationship is represented by “x7/x10”. The relational diagram 200 expresses that the variable x7 is a variable set for a “thickness of the heating portion”, and the variable x10 is a variable set for “heat conductivity of the heating portion”. Therefore, the relational diagram 200 expresses that the “heat transfer efficiency of the heating portion” is derived by “the thickness of the heating portion/the heat conductivity of the heating portion”. In other words, the relational diagram 200 expresses that x5=x7/x10.

A quantitative relationship set for each item may be a formula, and may be a constant. The constant may be a number, and may be expressed by a Greek letter. In the relational diagram 200 illustrated in FIG. 8, for example, n is set for the “circular constant”.

The server 10 presents a quantitative relationship between items having a relationship therebetween in association with display of items on a relational diagram as in the relational diagram illustrated in FIG. 8, and may thus present the relational diagram that facilitates visual recognition regarding the quantitative relationship between the items.

FIG. 8 illustrates an example in which the quantitative relationship 213 is presented inside the item display frame 210, but an exemplary embodiment of the present invention is not limited to the example.

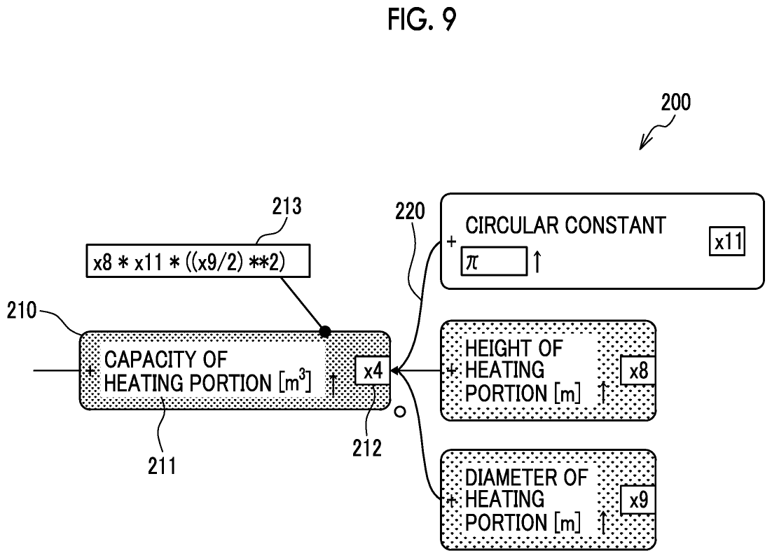

FIG. 9 is a diagram illustrating an example of a user interface provided to the user terminal 20 from the server 10. FIG. 9 illustrates a state in which a relational diagram 200 created by a user is displayed on the user interface.

In the relational diagram 200 illustrated in FIG. 9, item display frames 210 displaying respective items are connected to each other via a line 220 indicating a relationship between the items. An item's name 211 and an item's variable 212 are presented in the item display frame 210. In the relational diagram 200 illustrated in FIG. 9, a quantitative relationship 213 between items related to each item is presented in a state of being connected to the item display frame 210. As in the relational diagram illustrated in FIG. 9, the server 10 may present a quantitative relationship between items.

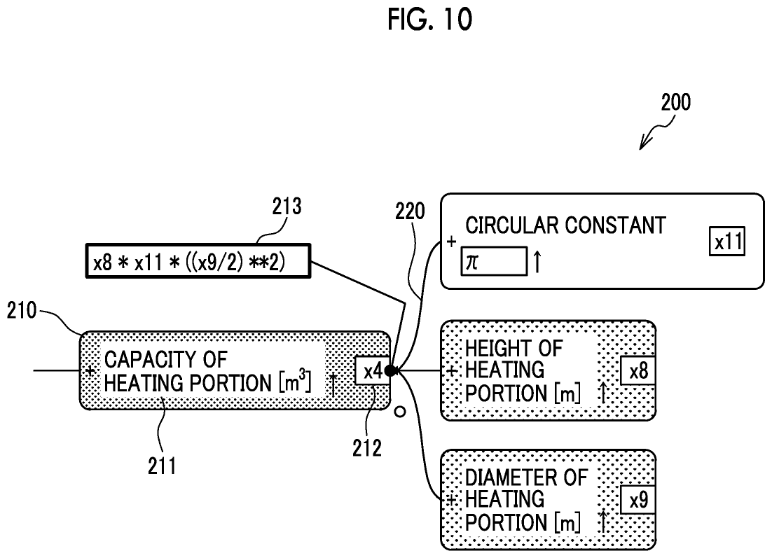

FIG. 10 is a diagram illustrating an example of a user interface provided to the user terminal 20 from the server 10. FIG. 10 illustrates a state in which a relational diagram 200 created by a user is displayed on the user interface.

In the relational diagram 200 illustrated in FIG. 10, item display frames 210 displaying respective items are connected to each other via a line 220 indicating a relationship between the items. An item's name 211 and an item's variable 212 are presented in the item display frame 210. In the relational diagram 200 illustrated in FIG. 10, a quantitative relationship 213 between items related to each item is presented in a state of being connected to the item display frame 210 at a location where lines extending from item display frames of items related to the item are bundled. In other words, the server 10 may present a quantitative relationship between items related to each item at a location where lines extending from a frame are bundled, the frame displaying an item corresponding to an event representing an associated cause with respect to an item corresponding to an event representing a result. As in the relational diagram illustrated in FIG. 10, the server 10 may present a quantitative relationship between items.

In a case where a quantitative relationship is presented by a formula, the formula is supposed to become longer as the number of related items increases. There may be a case where a quantitative relationship cannot be put in the item display frame 210 of the relational diagram 200. In a case where presentation regarding a quantitative relationship is longer than a predetermined amount, the CPU 11 may change a presentation position of the quantitative relationship from the inside of the frame displaying items on the relational diagram as illustrated in FIG. 8 to the outside of the frame as illustrated in FIG. 9 or 10.

The quantitative relationship is input by a user editing the relational diagram, and information regarding the quantitative relationship is registered in the server 10. Therefore, a quantitative relationship input by the user may not match a variable set for each item. The CPU 11 may change a display aspect of the quantitative relationship depending on whether or not matching of the quantitative relationship is made. The CPU 11 may perform presentation such that the quantitative relationship is surrounded by a solid line in a case where matching of the quantitative relationship is made, and such that the quantitative relationship is surrounded by a line such as a dashed line other than the solid line in a case where matching of the quantitative relationship is not made.

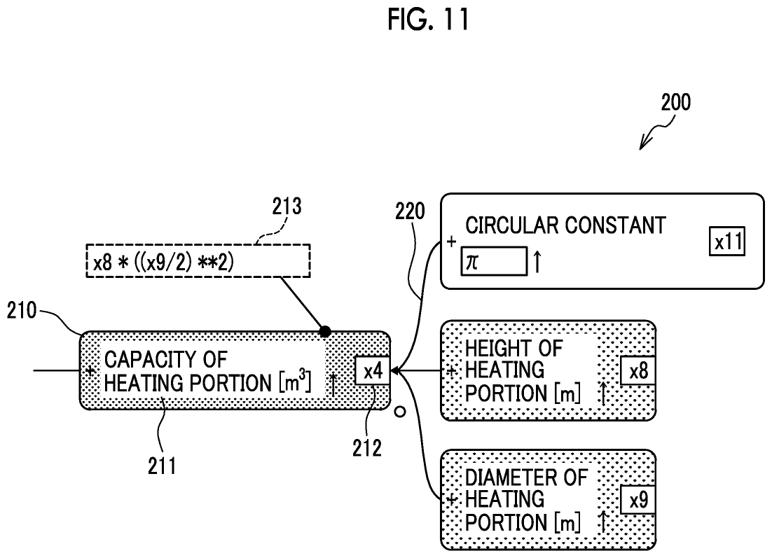

FIG. 11 is a diagram illustrating an example of a user interface provided to the user terminal 20 from the server 10. FIG. 11 illustrates a state in which a relational diagram 200 created by a user is displayed on the user interface. In a formula shown in a quantitative relationship 213 in FIG. 11, a variable x8 and a variable x9 are used, but a variable x11 is not used. Therefore, the CPU 11 determines that matching among items does not occur in the formula shown in the quantitative relationship 213, and presents the quantitative relationship 213 in a dashed line.

The CPU 11 may change a presentation aspect of a quantitative relationship depending on whether or not matching of the quantitative relationship is made, in addition to a solid line or a dashed line. For example, the CPU 11 may change a color of a formula presented as a quantitative relationship depending on matching of the quantitative relationship is made. For example, in a case where matching of a quantitative relationship is not made, the CPU 11 may present the quantitative relationship to blink. For example, in a case where matching of a quantitative relationship is not made, the CPU 11 may display a message indicating that the matching is not made on a relational diagram.

The server 10 may determine whether or not a quantitative relationship is also presented on a relational diagram in response to a user's operation. In other words, in response to the user's operation, the server 10 may present a relational diagram including a quantitative relationship to the user terminal 20, and may present a relational diagram not including a quantitative relationship to the user terminal 20.

The relational diagram including the quantitative relationship, presented from the server 10 to the user terminal 20, may be used to check a quantitative relationship of, for example, a physical phenomenon, a machine, or a mechanism. Since the relational diagram is used to check a quantitative relationship, a structure of a relationship between respective items and a quantitative relationship are expressed, and thus a user's visual understanding can be promoted.

An example will be described assuming simulation using a relational diagram. A user operates the user terminal 20 to input a relational expression between a design value and a characteristic value, indicating association between the design value and the characteristic value with a tree structure with respect to a mechanism. The server 10 presents the relational expression between the design value and the characteristic value on a relational diagram, and thus the user may simulate, on the relational diagram, a characteristic value obtained in a case of changing a design value, or a design value to be set in a case of moving an expected characteristic value.

In a case where a quantitative relationship between a design value and a quality output value is unclear with respect to a new function, the user collects the design value and the quality output value through tests. The user operates the user terminal 20 to update the respective items such as a design value and a quality output value to the collected test data. The user derives a relational expression by using a function estimation function using statistics or machine learning. In the function estimation function, a method such as multiple regression or genetic programming is selected. The user operates the user terminal 20 to input the obtained relational expression to the item of a quality output value. In a case where a quantitative relationship between a design value and a quality output value can be set, and the server 10 presents the quantitative relationship on a relational diagram, the user may simulate, on the relational diagram, a characteristic value obtained in a case of changing a design value, or a design value to be set in a case of changing an expected quality output value.

The server 10 according to the present exemplary embodiment may express a quantitative relationship between a cause and a result by using a formula model or the like. The server 10 may integrate “association” and a “quantitative relationship” scattered due to a use environment difference into a single relational diagram. There is no limitation to checking of a cause connected to a result, and the user may also understand a quantitative relationship from a relational diagram. Thus, the user can expedite decision making for a purpose in consideration of quantitativeness by referring to a relational diagram presented by the server 10.

The relational diagram generation process that is executed by the CPU reading software (program) maybe executed by various processors other than the CPU in the above-described respective exemplary embodiments. The processors in this case may include a programmable logic device (PLD) such as an FPGA, in which a circuit configuration is changeable after being manufactured, and a specific electric circuit such as an application specific integrated circuit (ASIC) that is a processor having a circuit configuration specially designed to execute a specific process. The relational diagram generation process may be executed by one of such various processors, and may be executed by a combination of identical or different types of two or more processors (for example, a combination of plural of FPGAs or a combination of a cup and an FPGA). A hardware structure of each of the various processors is, for example, an electric circuit into which circuit elements such as semiconductor elements are combined.

In the above-described respective exemplary embodiments, a description has been made of an aspect in which the program for the relational diagram generation process is stored (installed) in the ROM or the storage in advance, but this is only an example. The program may be provided in the form of being recorded on recording media such as a compact disk read only memory (CD-ROM), a digital versatile disk read only memory (DVD-ROM), and a Universal Serial Bus (USB) memory. The program may be provided in the form of being downloaded from an external apparatus via a network.

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
execute a process of presenting a quantitative relationship between a plurality of items having a relationship in association with display of the items on a relational diagram, the relational diagram being systematically created by connecting the items having the relationship to each other according to the relationship.

2. The information processing apparatus according to claim 1,
wherein the processor is configured to
present the quantitative relationship inside a frame displaying the item on the relational diagram.

3. The information processing apparatus according to claim 2,
wherein, in a case where presentation regarding the quantitative relationship is longer than a predetermined amount, the processor is configured to
change a presentation position of the quantitative relationship to an outside of the frame displaying the item on the relational diagram.

4. The information processing apparatus according to claim 1,
wherein the processor is configured to
connect the quantitative relationship to a frame displaying the item on the relational diagram and presents the quantitative relationship outside the frame.

5. The information processing apparatus according to claim 1,
wherein the processor is configured to
present the quantitative relationship at a location where lines extending from a frame are bundled, the frame displaying the item corresponding to an event representing an associated cause with respect the item corresponding to an event representing a result.

6. The information processing apparatus according to claim 1,
wherein the processor is configured to
change a display aspect of the quantitative relationship depending on whether or not matching of the quantitative relationship is made.

7. The information processing apparatus according to claim 6,
wherein the processor is configured to
present the quantitative relationship to be surrounded by a solid line in a case where the matching of the quantitative relationship is made, and presents the quantitative relationship to be surrounded by a line other than the solid line in a case where the matching of the quantitative relationship is not made.

8. The information processing apparatus according to claim 1,
wherein the quantitative relationship is a relationship represented by a formula using variables set for the respective connected items.

9. A non-transitory computer readable medium storing a computer program causing a computer to execute a process, the process comprising:
presenting a quantitative relationship between a plurality of items having a relationship in association with display of the items on a relational diagram, the relational diagram being systematically created by connecting the items having the relationship to each other according to the relationship.
